(19) United States
(12) Patent Application Publication
(10) Pub. No.: US 2008/0277076 A1
(43) Pub. Date: Nov. 13, 2008

(54) Window covering device

(75) Inventor: Li-Ming Cheng, Kaohsiung (TW)

Correspondence Address: Joe McKinney Muncy, PO Box 1364, Fairfax, VA, 22038-1364, US

(73) Assignee: ZIPSHADE INDUSTRIAL (B.V.I.) CORP

(21) Appl. No.: 11/798,007

(22) Filed: May 9, 2007

(51) Int. Cl. E06B 9/38

(52) U.S. Cl. 160/167 R

(57) ABSTRACT

A window covering device has a top elongated member, a middle elongated member, and a bottom elongated member. A window covering is mounted between the middle elongated member and the bottom elongated member. A middle elongated member controller is mounted in the top elongated member, and is connected with the middle elongated member through the top elongated member by the connection cord. A bottom elongated member controller is mounted in the bottom elongated member, and is connected with the top elongated member through the bottom elongated member, the window covering and the middle elongated member by the connection cord. The middle elongated member controller has a cord seat with a spiral spring, the cord seat has connection cord, and connected with the middle elongated member through the top elongated member, in order to control the middle elongated member.

### BACKGROUND OF THE INVENTION

1. Field of the Invention

The present invention relates to a window covering device without cord control, and particularly relates to a window covering device that is mounted in window or French window, and is opened either from top or from bottom without any cord controls.

2. Description of the Related Art

Conventional window covering device only allows a bottom of the window covering device to be risen or descended to open or close the window covering device. However, only the movement of the bottom can not perfectly adjust the in-door brightness.

So window covering devices opened either from top or from bottom are designed, which are most controlled by cords. The cords for controlling the window covering device normally extend out, which are dangerous for children, as the cords may wind a child's neck and threaten his/her life.

The design of window covering devices without cord control is only applied on bottom-opened window covering devices, but not for the window covering devices opened either from top or from bottom.

Therefore, the invention provides a window covering device opened either from top or from bottom without cord control to mitigate or obviate the aforementioned problems.

### SUMMARY OF THE INVENTION

The main objective of the present invention is to provide a window covering device without any cord controls.

The window covering device in accordance with the present invention has top elongated member, middle elongated member, and bottom elongated member. A window covering is mounted between the middle elongated member and the bottom elongated member. A middle elongated member controller is mounted in the top elongated member, and is connected with the middle elongated member through the top elongated member by the connection cord. A bottom elongated member controller is mounted in the bottom elongated member, and is connected with the top elongated member through the bottom elongated member, the window covering and the middle elongated member by the connection cord. The middle elongated member controller has a cord seat with a spiral spring, the cord seat has connection cord, and connected with the middle elongated member through the top elongated member, in order to control the middle elongated member.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of the spreading window covering device in accordance with the invention;

FIG. 2 is an operational exploded perspective view of the window covering device in FIG. 1 with the middle elongated member descending;

FIG. 3 is an exploded perspective view of the middle elongated member controller of the window covering device in FIG. 1;

FIG. 4 is a top view in partial section of the middle elongated member controller in the top elongated member in the window covering device in FIG. 1;

FIG. 5 is a top view in partial section of the first bottom elongated member controller of the window covering device in accordance with the present invention;

FIG. 6 is an exploded perspective view of the second bottom elongated member controller of the window covering device in FIG. 1;

FIG. 7 is a top view of the second bottom elongated member controller of the window covering device in FIG. 6;

FIG. 8 is an operational top view of the second bottom elongated member controller of the window covering device in FIG. 7 with the press member being pressed to separate the brake from the wind reel group;

FIG. 9 is top view of the third bottom elongated member controller of the window covering device in accordance with the present invention;

FIG. 10A is a perspective view of another embodiment of the window covering device;

FIG. 10B is a perspective view of another embodiment of the window covering device; and

FIG. 11 is an exploded view of the embodiment in FIG. 10A.

### DETAILED DESCRIPTION OF THE PREFERRED EMBODIMENT

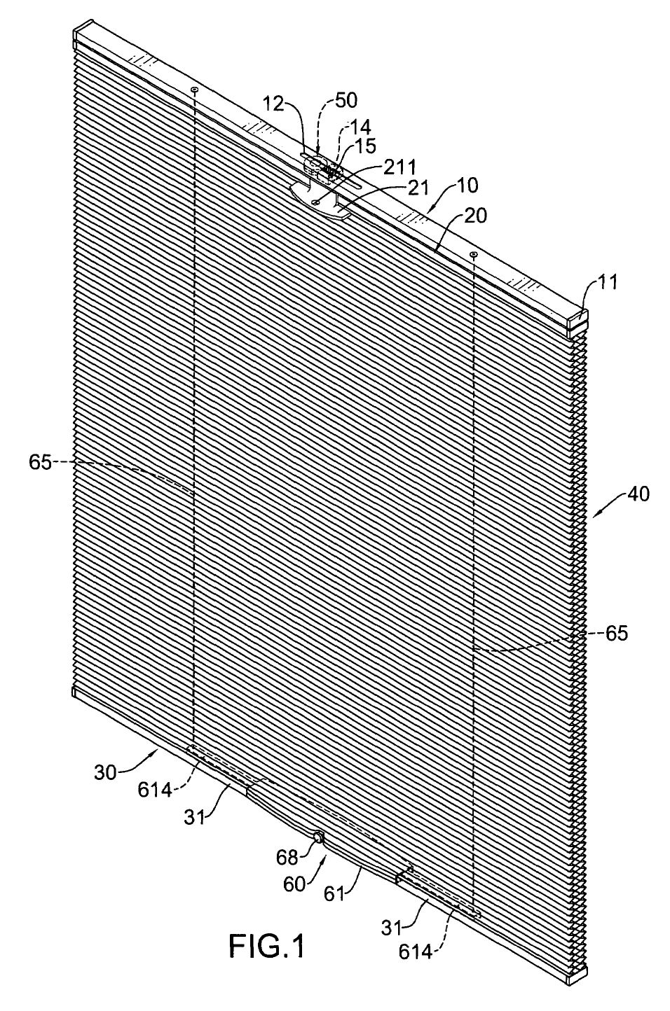

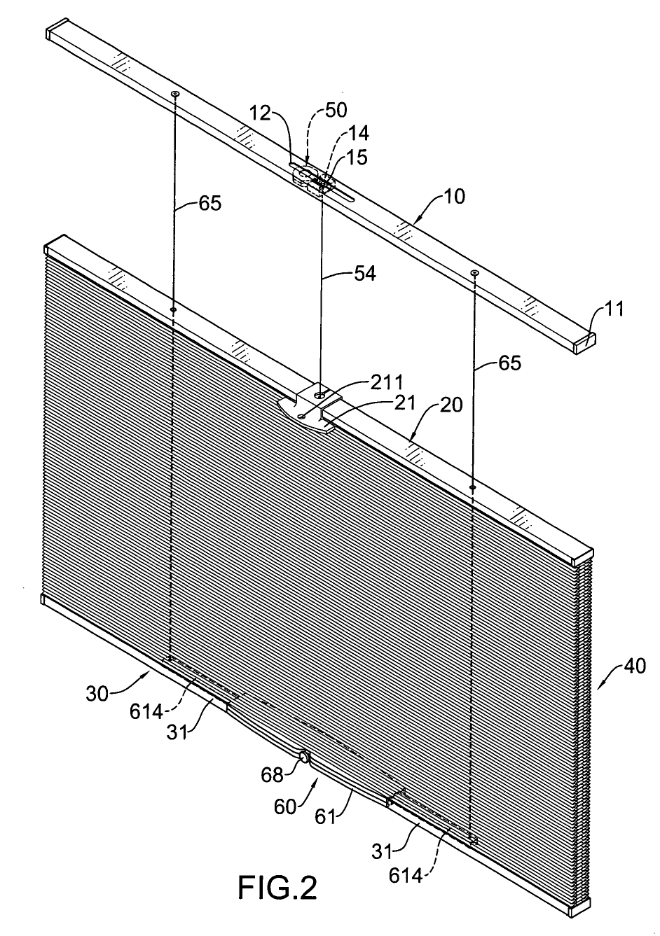

With reference to FIGS. 1-2, a window covering device in accordance with the invention has a top elongated member (10), a middle elongated member (20), a bottom elongated member (30), a window covering (40), a middle elongated member controller (50), and a bottom elongated member controller (60).

The top elongated member (10), middle elongated member (20), and bottom elongated member (30) are hollow, may be made of plastic material and are arranged in a row. Each elongated member (10, 20, 30) has two end caps (11) attached to two ends of the elongated member (10, 20, 30).

The window covering (40) is mounted between the middle elongated member (20) and the bottom elongated member (30).

The middle elongated member controller (50) is mounted in the top elongated member (10) to control the movement of the middle elongated member (20) without pulling cords.

The bottom elongated member controller (60) is mounted in the bottom elongated member (30) to control the movement of the bottom elongated member (30) without pulling cords.

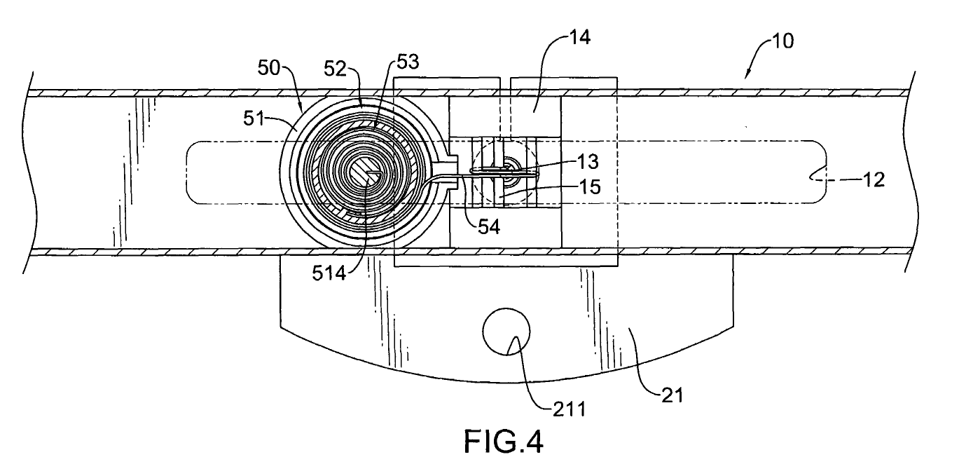

With reference to FIG. 4, the top elongated member (10) has a top surface, a bottom surface, at least one through hole (13) defined through the bottom surface. A cord seat (14) is mounted in the top elongated member (10) near the through hole (13) and has at least one guide rod (15). The top elongated member (10) may have a longitudinal hole (12) defined through the top surface to facilitate the mounting of the middle elongated member controller (50).

With reference to FIGS. 1-2, the middle elongated member (20) has a front surface and a pull board (21) mounted on the front face and having an orifice (211) defined therethrough.

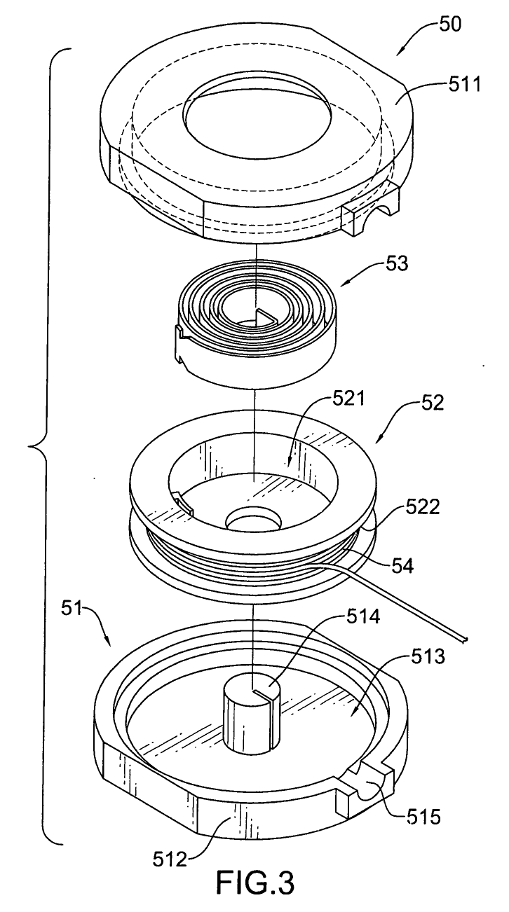

With reference to FIG. 3, the middle elongated member controller (50) has a first pivot pole (514), a first wind reel (52), a first spiral spring (53) and a first connection cord (54), and may have a first shell (51).

The first shell (51) comprises two half cases (511), (512), which are connected by screws, engagement, bonding or other connection methods. The first shell (51) has a cavity (513). A cord hole (515) is defined through a side of the first shell (51) and communicates with the cavity (513).

The first pivot pole (514) is directly mounted in the top elongated member (10), or as shown in this embodiment, the first pivot pole (514) is mounted in the cavity (513), and the first shell (51) is mounted in the top elongated member (10).

The first wind reel (52) is mounted in the cavity (53), is round and has a first pivot hole (523) defined through the first wind reel (52). The first wind reel (52) is mounted rotatably around first pivot pole (514) through the first pivot hole (523), thus the first wind reel (52) can revolve round the first pivot pole (514). A first chamber (521) is defined in a top of the first wind pulley (52), and a round valley (522) is defined radially in a periphery wall of the first wind reel (52).

The first spiral spring (53) is mounted in the first chamber (521) around the first pivot pole (514), and an inner end of the first spiral spring (53) is connected with the first pivot pole (514), and an outer end is connected with an inner wall of the first chamber (521).

The first connection cord (54) has two ends and one end connected with the first wind reel (52), and the other end extending out through the cord hole (515). A segment of the first connection cord (54) winds the guide rod (15) and is connected with the middle elongated member (20) through the through hole (13).

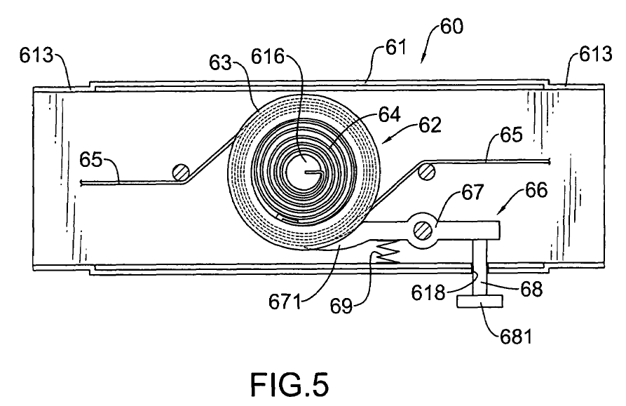

The bottom elongated member controller (60) in the bottom elongated member (30) has multiple embodiments. As shown in FIGS. 1 and 5, it is a first embodiment of the bottom elongated member controller (60). The bottom elongated member (30) is divided into two sub elongated members (31) and the bottom elongated member controller (60) is mounted between the two sub elongated members (31). The bottom elongated member controller (60) has a second shell (61), a second wind reel group (62), and a brake (66).

The second shell (61) comprises two half cases (611, 612). Two ends of the second shell (61) are hollow connection members (613), in order to connect respectively with the two sub elongated members (31). A second pivot pole (616) is provided in the second shell (61), and a mounting hole (618) is defined through a front surface of the second shell (61).

The second wind reel group (62) is provided in the second shell (61) and has a second wind reel (63), a second spiral spring (64) and at least one second connection cord (65). The second wind reel (63) is mounted rotatably around the second pivot pole (616). The second spiral spring (64) is secured in the second wind reel (63) and has two ends. One end of the spiral spring (64) is connected to the second pivot pole (616), and the other end is connected to the second wind reel (63). The second connection cord (65) is connected to the second wind reel (63) with one segment, winds around the second wind reel (63), and both ends of the second connection cord (65) extend through the hollow connection member (613), the bottom elongated member (30), the window covering (40), and the middle elongated member (20), then are connected to the top elongated member (10).

The brake (66) is provided in the second shell (61), and has a brake lever (67), a press member (68) and an elastic member (69). The brake lever (67) is mounted pivotally in the second shell (61) and has two ends. A curved pawl (671) is formed on one end of the brake lever (67) and abuts the second wind reel (63). The press member (68) has a button (681), which is provided out of the second shell (61), and the press member (68) is connected to the other end of the brake lever (67) through the mounting hole (618). The elastic member (69) is mounted between the brake lever (67) and the second shell (61), to provide an elastic force to the curved pawl (671), so that the curved pawl (671) keeps abutting the second wind reel (63) in normal state, and the second wind reel (63) will not revolve.

When the invention is applied on a window, the top elongated member (10) is fixed on the window frame. The press member (68) is pressed to push the curved pawls (671) to separate from the second wind reel (63). Meanwhile, the window covering (40) is pulled down. When the window covering (40) spreads to a certain position, the press member (68) is released, and the brake lever (67) engages with and makes the curved pawl (671) abut the second wind reel (63) again, to stop the wind reels from revolving, thus the bottom elongated member (30) is kept in the certain position. When the bottom elongated member (30) is raised up, the operation is similar to the above steps, and window covering (40) is pushed to fold.

In addition, when the window covering (40) is spread, the middle elongated member (20) pulls an upper part of the window covering (40) to fold through the middle elongated member controller (50). The pull board (21) is pulled, and then the pull board (21) brings the middle elongated member (20) as well as the window covering (40). While the middle elongated member (20) is descending, the middle elongated member (20) revolves the first wind reel (52), and releases the first connection cords (54). When the middle elongated member (20) comes to a certain position, the first spiral spring (53) provides an elastic force, which is equal to the weight of the middle elongated member (20) in a certain position. When the middle elongated member (20) is raised up, the operation is similar to the above steps. Thus the window covering device can opens either from top or from bottom.

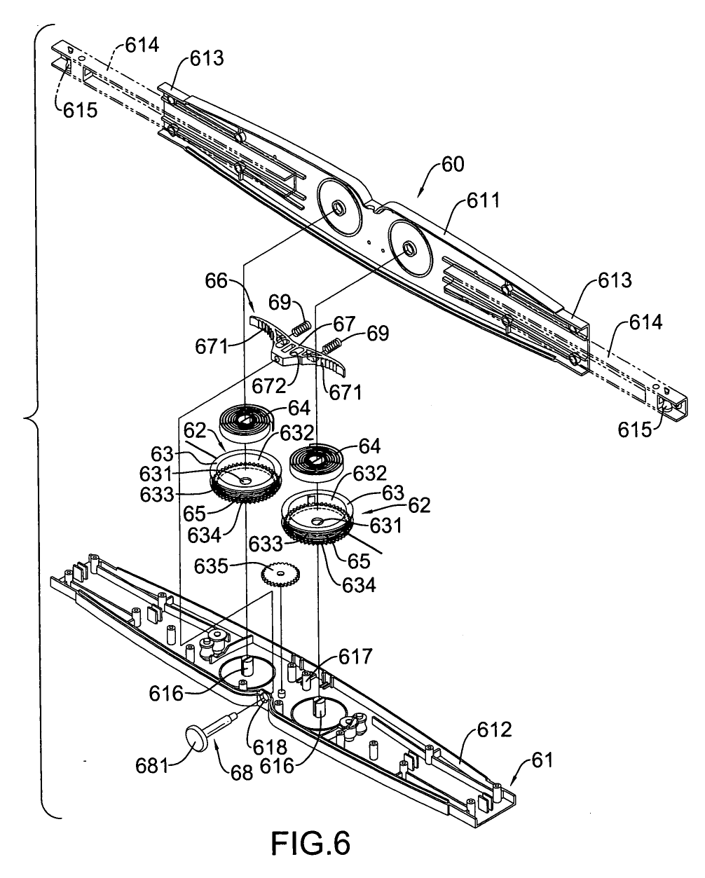

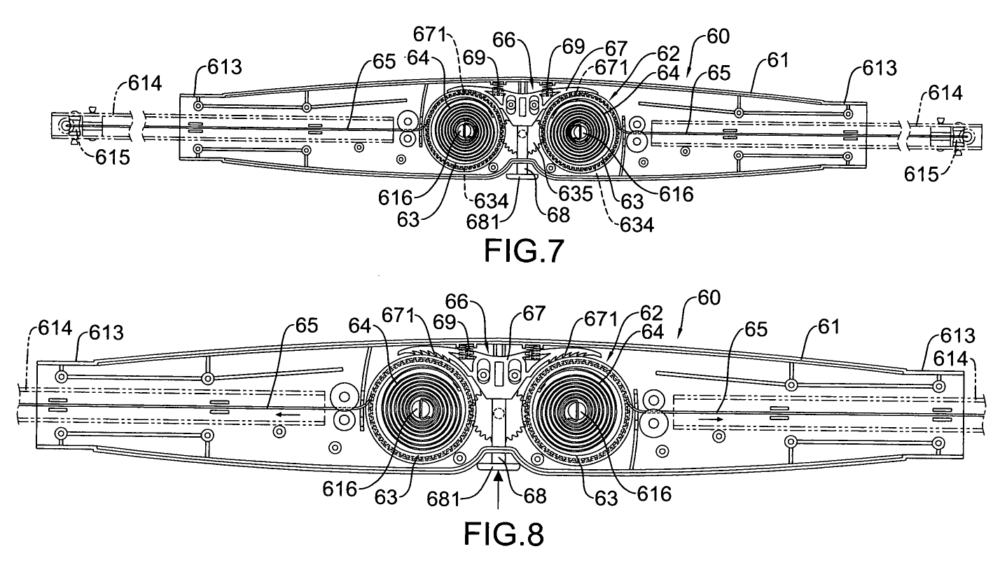

As shown in FIGS. 6-7, in another embodiment, the bottom elongated member controller (60) includes a second shell (61a), a wind reel group (62a), and a brake (66a).

The second shell (61a) comprises a top half case (611), a bottom half case (612) connected by screws, engagement, bonding or other connection methods. Two ends of the second shell (61a) are hollow connection members (613), and are connect respectively with the two sub elongated members (31). Each of the two hollow connection members (613) is connected with a guide elongated member (614). The guide elongated member (614) extends in one of the two sub elongated members (31) and has a distal end. Two wheels (615) are mounted respectively in the distal ends of the guide elongated members (614). The bottom half case (612) has two second pivot poles (616). at least one limitation pole (617) is formed between the two second pivot pole (616). The second shell (61) has a mounting hole (618) defined through a front surface.

The wind reel group (62a) is provided in the second shell (61), and has two second wind reels (63), two second spiral springs (64) and two second connection cords (65). Each of the two second wind reels (63) has a second pivot hole (631) defined therein. The two second wind reels (63) are rotatably mounted respectively around the two second pivot poles (616) through the second pivot holes (631), thus the two second wind reels (63) are rotatably mounted and can revolve respectively around the second pivot poles (616). Each second wind reel (63) has a second chamber (632) defined therein, and a round valley (633) defined radially in a periphery wall. The two second spiral springs (64) are secured respectively in the second chamber (632). Each of the second spiral springs (64a) has an inner end connected with one of the second pivot poles (616) and an outer end connected with an inner wall of one of the second chambers (632). Each of the two second connection cords (65) has two ends, is connected to one of the second wind reels (63) with one end, winds around the second wind reel (63) in the round valley (633), and extends out through one of the hollow connection members (613), along one of the guide elongated members (614), and wind around one of the wheels (615), and is further connected to the one end of the middle elongated member (10) through the bottom elongated member (30), the window coverings (40), and the middle elongated member (20).

The second wind reel group (62a) further includes a gear (635) mounted rotatably between the two second wind reels (63). Each second wind reel (63) has a gear portion (634) engaged with the gear (635). Thus the two second wind reels (63) revolve simultaneously.

The brake (66a) is provided in the second shell (61), and has a brake block (67a), a press member (68) and at least one elastic member (69). The brake block (67a) has two curved pawls (671) formed in two sides, and at least a longitudinal hole (672) slidably holding the at least one limitation pole (617). The two curved pawls (671) respectively abut the two second wind reels (63). The press member (68) has a button (681), the press member (68) is connected with the brake block (67a) through the mounting hole (618). The at least one elastic member (69) is mounted between the brake block (67a) and the second shell (61) to provide an elastic force to the curved pawl (671), so that the curved pawls (671) keep abutting the second wind reels (63) respectively in normal state, and the second wind reels (63) will not revolve.

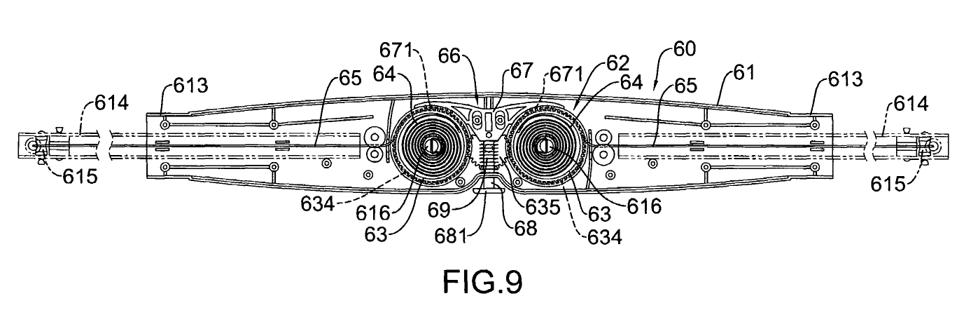

With reference to FIGS. 6-8, The brake (66a) has two elastic members (69), which are compression springs and correspond respectively to the curved pawls (671). Each of the two elastic members (69) is mounted between a corresponding curved pawl (671) and an inner wall of the second shell (61). The press member (68) is mounted between the two elastic members (69).

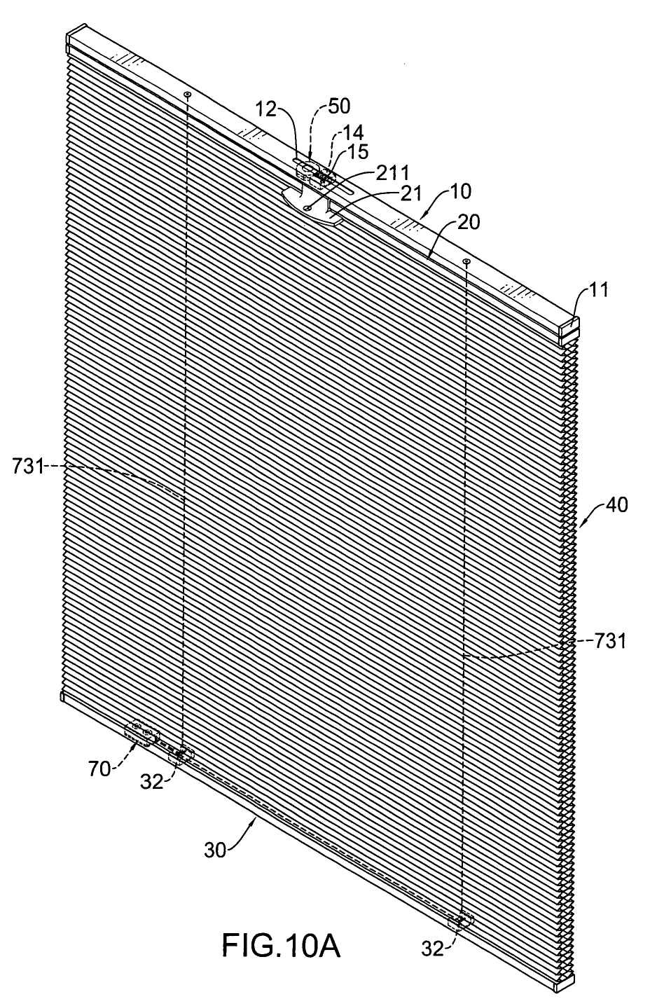

With reference to FIG. 9, another embodiment of the window covering device has one elastic member being a tension spring, mounted around the press member (68) and mounted between the brake block (67a) and the second shell (61).

When the invention is applied on a window, the top elongated member (10) is fixed on the window elongated member. The press member (68) is pressed to push the curved pawls (671) to separate from the two second wind reels (63). Meanwhile, the window covering (40) is pulled down. When the window covering (40) spreads to a certain position, the press member (68) is released, and the brake block (67a) engages with and makes the two curved pawls (671) abut the two second wind reels (63) respectively again, to stop the wind reels from revolving, thus the bottom elongated member (30) is kept in the certain position. When the bottom elongated member (30) is raised up, the operation is similar to the above steps, and bottom window covering (40) is pushed to fold.

In addition, when the window covering (40) is spread, the middle elongated member (20) pulls an upper part of the window covering (40) to fold through the middle elongated member controller (50). The pull board (21) is pulled, and then the pull board (21) brings the middle elongated member (20) as well as the window covering (40). While the middle elongated member (20) is descending, the middle elongated member (20) revolves the first wind reel (52), and releases the first connection cords (54). When the middle elongated member (20) comes to a certain position, the first spiral spring (53) provides an elastic force, which is equal to the weight of the middle elongated member (20) in a certain position. When the middle elongated member (20) is raised up, the operation is similar to the above steps. Thus the window covering device can opens either from top or from bottom.

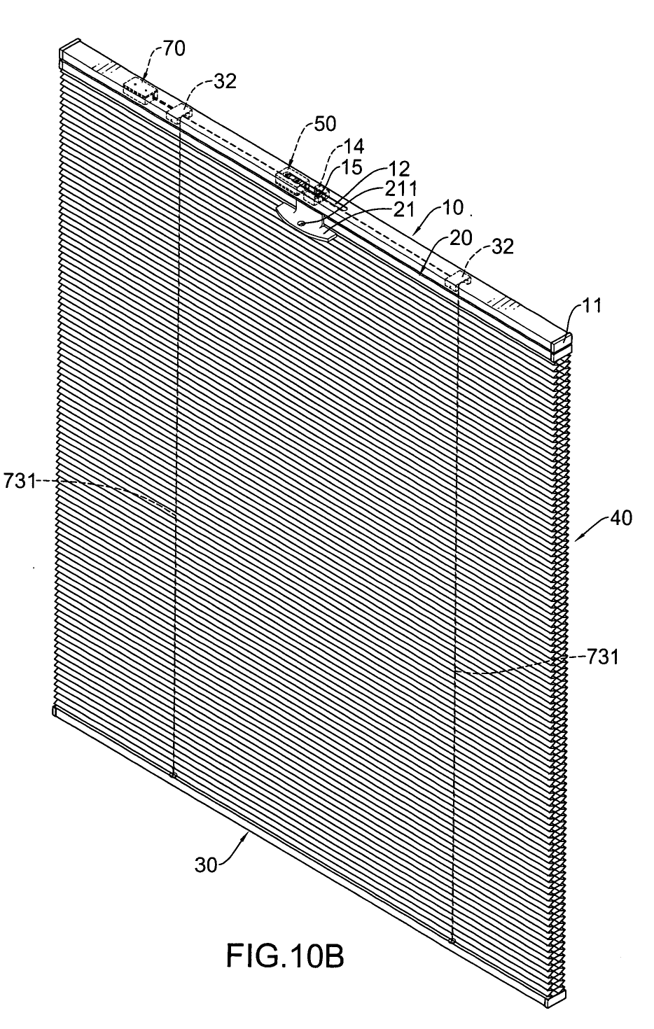

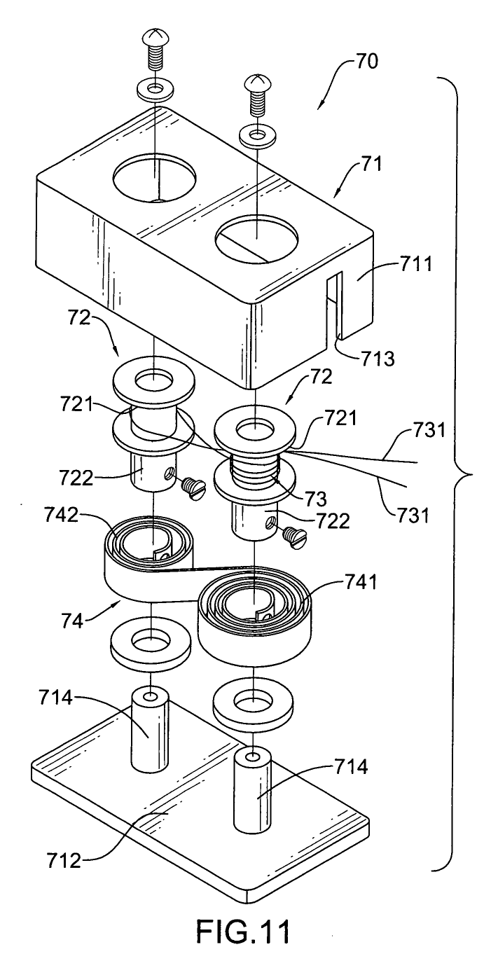

With reference to FIGS. 10A and 11, it is another embodiment of the bottom elongated member controller (70). The bottom elongated member (30) is a single elongated member, and the bottom elongated member (30) can have multiple wheels or guide rods (32). The bottom elongated member controller (70) is mounted in the bottom elongated member (30), and has two third pivot poles (714), two third wind reels (72), a third connection cord (73) and a reversible spring (74), and may have a third shell (71).

The third shell (71) comprises two half cases (711, 712), and a cord-through hole (713) is defined through a side of the third shell (71).

The two third pivot poles (714) are mounted on the bottom elongated member (30), or the two third pivot poles (714) are mounted in the third shell (71), and the third shell (71) is mounted in the bottom elongated member (30).

The two third wind reels (72) are mounted in the third shell (71), and rotatably mounted respectively around the two third pivot poles (714). Each of the two third wind reels (72) has a round valley (721) defined radially in a periphery wall of the third wind reel (72) and a sleeve (722) extending from the third wind reel (72).

The third connection cord (73) has an end connected with a third wind reel (72), and winds the two third wind reels (72) along a 8-shaped path. The other end of the third connection cord (73) is connected with two cords (731) directly so the cords (731) wind respectively through the guide rods (32), and then through the bottom elongated member (30), window covering (40), and middle elongated member (20), to connect with the top elongated member (10).

The reversible spring (74) has two ends respectively forming two coils (741, 742) reversely. The two coils (741, 742) are winded respectively around the sleeves (722) and each of the coils (741, 742) has a distal end. The distal ends of the two coils (741), (742) are fixed to the sleeves (722).

The bottom elongated member (30) can be pulled directly, meanwhile, the connection cord (73) is stretched, and the two third wind reels (72) are pulled to revolve, and the connection cord (73) is released. One coil (741, 742) of the reversible spring (74) is released when the other coil (741, 742) is contracted. When the bottom elongated member (30) comes to a certain position, the reversible spring (74) provides an elastic force, which is equal to the bottom elongated member (30) and part of the window covering (40). When the bottom elongated member (30) is raised up, the operation is similar to the above steps.

With reference to FIG. 10B, an embodiment of the window covering device is similar to the embodiment in FIG. 10A and has the bottom elongated member controller (70) and the guide rods (32) mounted in the top elongated member (10). The cords (731) connecting with the third connection cord (73) wind respectively through the guide rods (32), extends through the top elongated member (10), the window covering (40) and the middle elongated member (20) and then connect securely with the bottom elongated member (30).

The window covering device is operated without any cord controls so children would be safe when playing near the window covering device.

It is to be understood, however, that even though numerous characteristics and advantages of the present invention have been set forth in the foregoing description, together with details of the structure and function of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A window covering device comprising a top elongated member, a middle elongated member, a bottom elongated member, a window covering, a middle elongated member controller and a bottom elongated member controller; wherein:
the top elongated member, middle elongated member, and bottom elongated member are arranged in a row;
the window covering is mounted between the middle elongated member and the bottom elongated member;
the middle elongated member controller is provided in top elongated member and has a first connection cord connected with the middle elongated member through the top elongated member;
the bottom elongated member controller is provided in the bottom elongated member, and has at least one second connection cord connected with the top elongated member through the bottom elongated member, the window covering, and the middle elongated member; and
the middle elongated member controller has a pivot pole mounted in the top elongated member, a wind reel mounted rotatably around the pivot pole, a spiral spring mounted around the pivot pole, two ends of the spiral spring connected respectively to the pivot pole and the wind reel, and the first connection cord winds the wind reel, has two ends and one end is connected to the wind reel and the other end is connected to the middle elongated member through the top elongated member.

2. The window covering device as claimed in claim 1, wherein the bottom elongated member controller has a second shell, a wind reel group, and a brake.

3. The window covering device as claimed in claim 2, wherein a second pivot pole is provided in the second shell;
the wind reel group is provided in the second shell and has a second wind reel, a second spiral spring and at least one second connection cord, the second wind reel is mounted rotatably around the second pivot pole, the second spiral spring has two ends, one end of the second spiral spring is connected to the second pivot pole, and the other end is connected to the second wind reel, the second connection cord is connected to the second wind reel with one segment, winds around the second wind reel, and at least one end of the second connection cord extends through the bottom elongated member, the window covering, and the middle elongated member, and are connected to the top elongated member; and
the brake is provided in the second shell, and has a curved pawl, a press member and an elastic member, the elastic member push curved pawl to abut the second wind reel, the press member drives the curved pawl away from the second wind reel.

4. The window covering device as claimed in claim 2, wherein the second shell comprises two second pivot poles, the second shell has a mounting hole defined through a front surface;
the wind reel group is provided in the second shell, and has two second wind reels, two second spiral springs and two second connection cords, the two second wind reels are rotatably mounted respectively around the two second pivot poles, the two second spiral springs are secured respectively in the second wind reels, each of the second spiral spring has an inner end connected with one of the second pivot poles, and an outer ends connected with one of the second wind reels, each of the two second connection cords has two ends, is connected to one of the second wind reels with one end, winds around the second wind reel, and the other end is connected to the top elongated member through the bottom elongated member, the window covering, and the middle elongated member; and
the brake is provided in the second shell, and has a brake block, a press member and at least one elastic member, the brake block has two curved pawls formed in two sides, the two curved pawls respectively abut the two second wind reel, the press member is connected with the brake block through the mounting hole, the at least one elastic member is mounted between the brake block and the second shell.

5. The window covering device as claimed in claim 1, wherein the middle elongated member controller has a first shell, the first shell has a cavity, and a cord hole is defined through a side of the first shell and communicates with the cavity, the pivot pole, the wind reel, and the spiral spring are provided in the cavity, and the first connection cord is connected with the middle elongated member through the cord hole and the top elongated member.

6. The window covering device as claimed in claim 1, wherein a chamber is defined on the top of the first wind reel, and a round valley is defined radially in a periphery wall of the first wind reel.

7. The window covering device as claimed in claim 1, wherein the top elongated member has a top surface, a bottom surface, a through hole defined through the bottom surface, a cord seat is mounted in the top elongated member near the through hole, and has at least one guide rod, the first connection cord is connected with the middle elongated member through the guide rod, and the through hole.

8. The window covering device as claimed in claim 1, wherein the middle elongated member has a pull board mounted thereon.

9. The window covering device as claimed in claim 2, wherein the bottom elongated member is divided into two sub elongated members, two ends of the second shell are hollow connection members, and are connected respectively with the two sub elongated members.

10. The window covering device as claimed in claim 4, wherein the brake has two compression springs corresponding respectively to the curved pawls, the each of the two compression springs is mounted between a corresponding curved pawl and an inner wall of the second shell.

11. The window covering device as claimed in claim 4, wherein the brake has one tension spring mounted between the brake block and the second shell, and the press member is mounted through the tension spring.

12. The window blind without cord control as claimed in claim 2, wherein:
the bottom elongated member is divided into two sub elongated members;
two guide elongated members are connected respectively with the two ends of the second shell and extend respectively in the sub elongated members and each guide elongated member has a distal end;
two wheels are mounted respectively in the guide elongated members; and
the second connection cords are wind respectively around the wheels.

13. The window covering device as claimed in claim 4, wherein the second wind reel group further includes a gear mounted rotatably between the two second wind reels, each second wind reel has a gear portion engaged with the gear.

14. The window covering device as claimed in claim 1, wherein:
the bottom elongated member is a single elongated member, the bottom elongated member controller is mounted in the bottom elongated member, and has two third pivot poles, two third wind reels, a third connection cord and a reversible spring;
the two third pivot poles are mounted on the bottom elongated member;
the two third wind reels are rotatably mounted respectively around the two third pivot poles, each of the two third wind reels has a round valley;
the third connection cord has two ends and an end is connected with a third wind reel, and winds the two third wind reels, the other end extends through the bottom elongated member, window covering, and middle elongated member, to connect with the top elongated member; and
the reversible spring has two ends respectively forming coils reversely, and the two coils are winded respectively around the third wind reels, each of the coils has a distal end, and the distal ends of the two coils are fixed to the third wind reels.

15. The window covering device as claimed in claim 14, wherein the third connection cord is connected with two cords and the cords wind respectively through two guide rods in the bottom elongated member and then through the bottom elongated member, window covering, and middle elongated member, to connect with the top elongated member.

16. The window covering device as claimed in claim 14, wherein the bottom elongated member controller has a third shell, the third pivot poles, the third wind reels, and the reversible spring are all mounted therein, and one end of the third connection cord is connected to the third wind reels, and the third connection cord winds around the two third wind reels, then the other end of the third connection cord is connected to the top elongated member through the bottom elongated member, the window covering and the middle elongated member.

17. A window covering device comprising a top elongated member, a middle elongated member, a bottom elongated member, a window covering, a middle elongated member controller and a bottom elongated member controller; wherein:
the top elongated member, middle elongated member, and bottom elongated member are arranged in a row;
the window covering is mounted between the middle elongated member and the bottom elongated member;
the middle elongated member controller is provided in top elongated member and has a first connection cord connected with the middle elongated member through the top elongated member;
the bottom elongated member controller is provided in the top elongated member, and has two second connection cords connected with the bottom elongated member through the top elongated member, the window covering, and the middle elongated member; and
the middle elongated member controller has a pivot pole mounted in the top elongated member, a wind reel mounted rotatably around the pivot pole, a spiral spring mounted around the pivot pole, two ends of the spiral spring connected respectively to the pivot pole and the wind reel, and the first connection cord winds the wind reel, has two ends and one end is connected to the wind reel and the other end is connected to the middle elongated member through the top elongated member.

18. The window covering device as claimed in claim 17, wherein:
the bottom elongated member is a single elongated member, the bottom elongated member controller is mounted in the top elongated member, and has two third pivot poles, two third wind reels, a third connection cord and a reversible spring;
the two third pivot poles are mounted on the top elongated member;
the two third wind reels are rotatably mounted respectively around the two third pivot poles, each of the two third wind reels has a round valley;
the third connection cord has two ends and an end is connected with a third wind reel, and winds the two third wind reels, the other end extends through the top elongated member, window covering, and middle elongated member, to connect with the top elongated member; and
the reversible spring has two ends respectively forming coils reversely, and the two coils are winded respectively around the third wind reels, each of the coils has a distal end, and the distal ends of the two coils are fixed to the third wind reels.

19. The window covering device as claimed in claim 18, wherein:
the third connection cord is connected with two cords and the cords wind respectively through two guide rods in the top elongated member and then through the top elongated member, window covering, and middle elongated member, to connect with the bottom elongated member.
